(19) United States
(12) Patent Application Publication
(10) Pub. No.: US 2013/0218951 A1
(43) Pub. Date: Aug. 22, 2013

(54) System and Method for Patient Contact

(71) Applicant: Smart-ER, LLC, (US)

(72) Inventor: Thomas A. Scaletta, La Grange, IL (US)

(73) Assignee: Smart-ER, LLC, La Grange, IL (US)

(21) Appl. No.: 13/746,838

(22) Filed: Jan. 22, 2013

Related U.S. Application Data
(60) Provisional application No. 61/600,931, filed on Feb. 20, 2012.

(51) Int. Cl. H04L 29/08

(52) U.S. Cl. CPC H04L 67/02
USPC 709/203

(57) ABSTRACT

A system and method of collecting feedback from a user is disclosed. The system and method may include providing a server capable of storing a survey and generating a unique link to access the survey on the server, the server further capable of sending the unique link to at least one of the user and a callback clerk. The system and method may also include completing the survey by the user and returning the completed survey to the server, determining by the server if any actions in the completed survey have been triggered and gathering the responses in the survey into at least one report by the server.

### CROSS-REFERENCE TO RELATED APPLICATIONS

This is a non-provisional U.S. patent application, which claims priority under 35 U.S.C. §119(e) to U.S. Provisional Patent Application No. 61/600,931 filed on Feb. 20, 2012, the entirety of which is incorporated by reference herein.

### TECHNICAL FIELD OF THE DISCLOSURE

The present disclosure relates generally to medical facilities and, more particularly, to a system and method for facilitating contact with patients discharged from medical facilities.

### BACKGROUND OF THE DISCLOSURE

Patients discharged from a medical facility, such as an emergency department, outpatient procedure area, or a hospital, greatly benefit from timely contact. Follow-up assessments not only address patient's well being, medication compliance, and adherence to discharge instructions, assessments also determine if a patient's medical condition is worse relative to the time of discharge. Addressing any patient concerns in such a way actively reduces claims and patient re-admissions. Patient contact and assessment is often also utilized to solicit feedback regarding various aspects of the patient's visit to the medical facility. For example, patients may be asked to evaluate hospital staff and care provider performance. Patients may also be asked to comment about the medical facility itself.

Conventionally, patient contact and assessment after discharge have been achieved through phone calls. Phone call contacts have several disadvantages. For example, a callback staff is required to be maintained at all times to keep track of discharged patients and to timely contact them upon discharge. Maintaining the callback staff is not only expensive for the medical facility, it also requires that the callback staff be diligent in actively contacting and, if necessary, re-contacting discharged patients. Further, even if the callback staff is diligent, patients may not be available to answer callback staff phone calls and/or may choose not to return any missed calls from the callback staff. Thus, the callback staff may not always be able to timely contact the patient, whose health condition may have already deteriorated by the time of contact. On other occasions, the callback staff may not be able to establish contact with the patient at all. Critical feedback about health care providers and the medical facility itself is also often not collected in callback staff phone calls.

Accordingly, it would be beneficial if a system and method could be developed to facilitate active contact with discharged patients in a timely and efficient manner. It would additionally be beneficial if such a system and method could, in addition to addressing patient concerns, also provide the patient flexibility in choosing how and when to respond back to the medical facility.

### SUMMARY OF THE DISCLOSURE

In accordance with one aspect of the present disclosure, a method of collecting feedback from a user is disclosed. The method may include providing a server capable of storing a survey and generating a unique link to access the survey on the server, the server further capable of sending the unique link to at least one of the user and a callback clerk. The method may also include completing the survey by the user and returning the completed survey to the server, the server capable of compiling responses in the survey. The method may additionally include determining by the server if any actions in the completed survey have been triggered, the server further capable of at least indirectly addressing the triggered actions and gathering the responses in the survey into at least one report by the server.

In accordance with another aspect of the present disclosure, a system to collect feedback from a user is disclosed. The system may include a server capable of storing a survey and generating a unique link to access the survey on the server, the server further capable of sending the unique link to at least one of the user and a callback clerk using a web enabled device. The system may also include a user profile document designed to be automatically uploadable to the server, the survey tailored to the user profile, on-duty staff for quickly addressing a first type of user concern, designated directors for addressing concerns of a client and a second type of user concern and a reporting system for collecting information from the survey for future use.

In accordance with yet another aspect of the present disclosure, a method of contacting a patient discharged from a medical facility is disclosed. The method may include providing a server capable of storing a survey and generating a unique link to access the survey on the server, the server further capable of sending the unique link to at least one of a patient and a callback clerk. The method may also include creating a patient profile document for the patient by the medical facility and uploading the patient profile document on the server, creating the survey tailored to the patient profile document by the medical facility, uploading the survey on the server and completing the survey by the patient using at least one of a web enabled device and the callback clerk. The method may further include returning the completed survey to the server, reviewing the completed survey by the server to determine if any actions have been triggered and addressing the triggered actions by the server.

These and other aspects and features of the present disclosure will be more readily understood upon reading the following description when taken in conjunction with the accompanying drawings.

### BRIEF DESCRIPTION OF THE DRAWINGS

FIG. 1 is a schematic diagram for setting up a client to use a patient callback system, in accordance with at least some embodiments of the present disclosure;

FIG. 2 is a block diagram of the patient callback system of FIG. 1, in accordance with at least some embodiments of the present disclosure; and

FIG. 3 is a flowchart outlining steps of contacting a patient discharged from a medical facility using the patient callback system of FIG. 2.

While the present disclosure is susceptible to various modifications and alternative constructions, certain illustrative embodiments thereof, will be shown and described below in detail. It should be understood, however, that there is no intention to be limited to the specific embodiments disclosed, but on the contrary, the intention is to cover all modifications, alternative constructions, and equivalents falling within the spirit and scope of the present disclosure.

### DETAILED DESCRIPTION OF THE DISCLOSURE

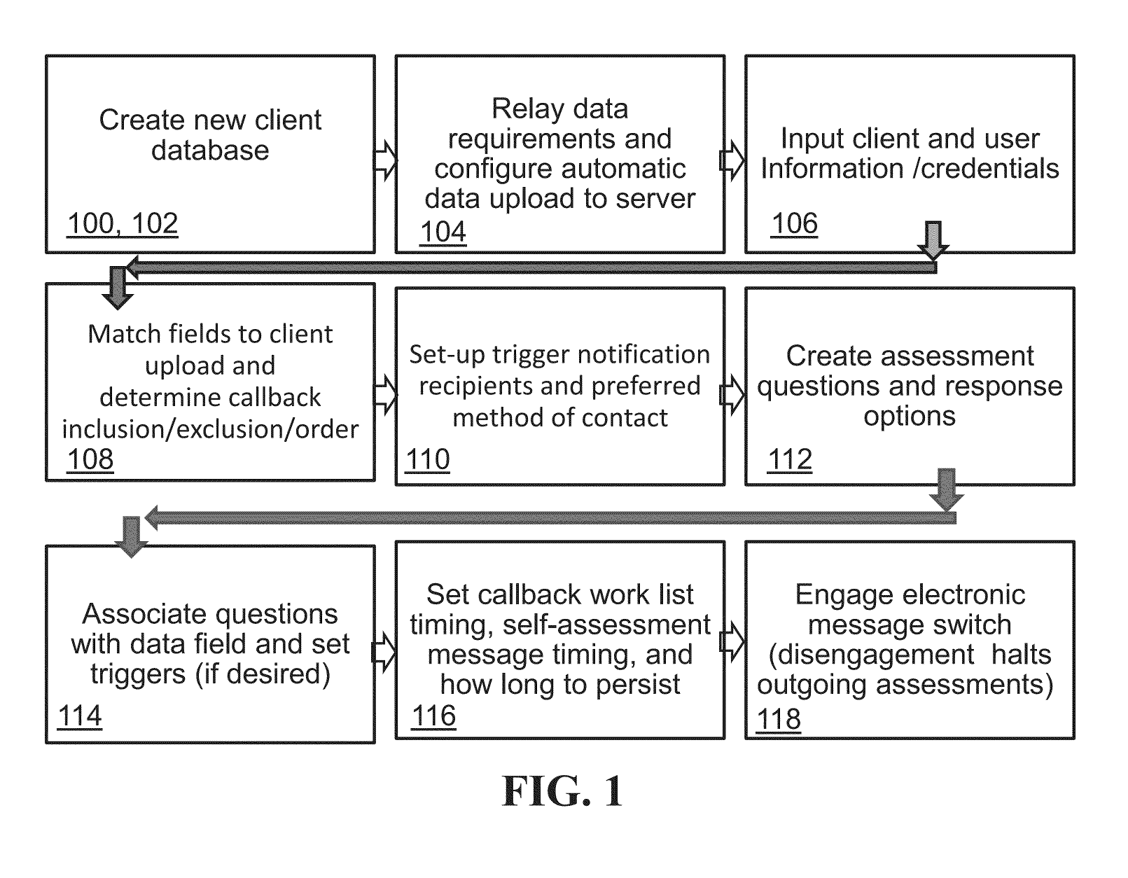

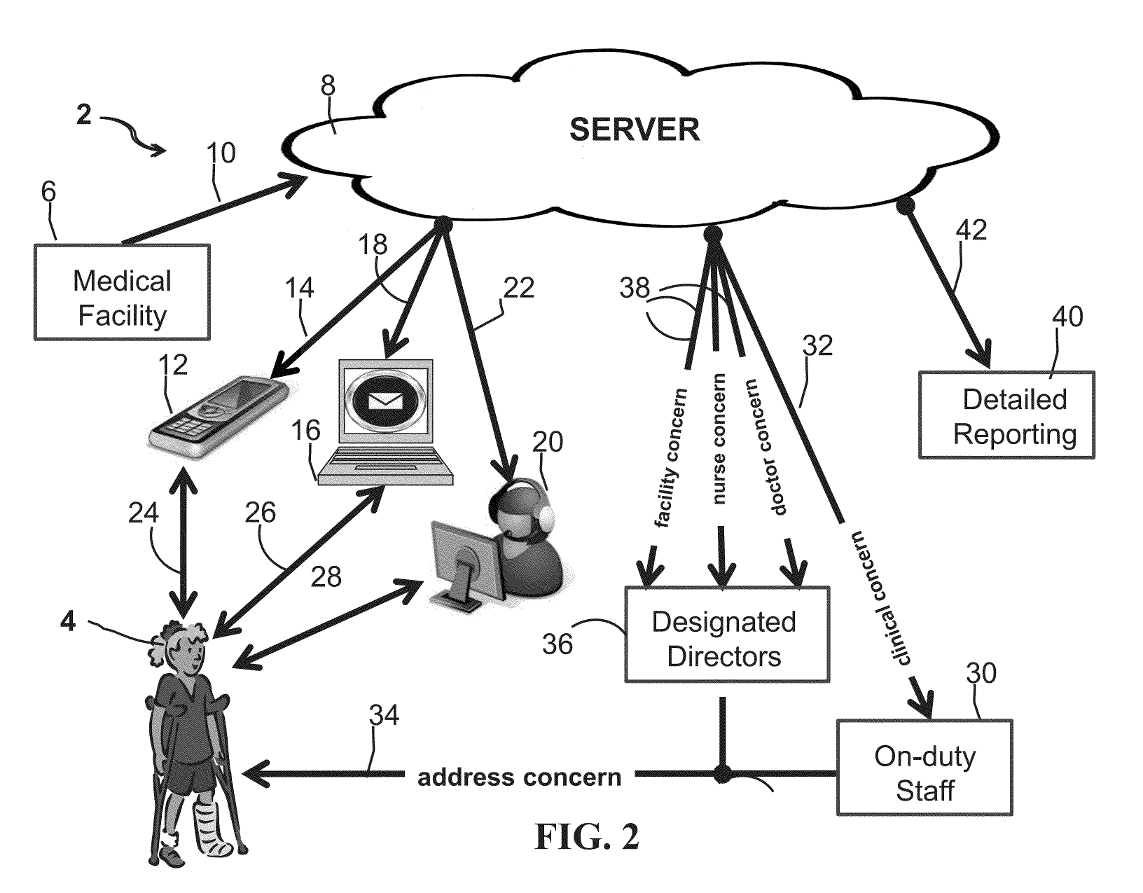

Referring to FIG. 1, a schematic diagram for setting up a client 100 for using a patient callback system 2 (See FIG. 2) is shown, in accordance with at least some embodiments of the present disclosure. In at least some embodiments, the client 100 may be representative of a medical facility 6 (See FIG. 2) such as any hospital or clinic, including, but not limited to, inpatient and outpatient procedure centers, dental offices, chiropractic clinics, physical therapy clinics, rehabilitation facilities, veterinary clinics and other types of healthcare entities that render any sort of medical or otherwise therapeutic treatments to patients. To facilitate setup of the client 100, a new client database 102 may be first created. In at least some embodiments, the client database 102 may be created by forming a partition on a server 8 (Again, see FIG. 2) and by providing basic client information such as name and contact details of the client.

After creating the client database 102, other information/preferences of the client 100, such as manner of communication with the patients, trigger notifications, etc. may be set, as described below. The client 100 may also identify any directors and any on-duty staff to notify of the trigger notifications, as well as the manner in which to notify them. Thus, after creating the client database 100, a variety of data requirements 104 may be relayed to the server 8 and the client database may be configured for automatic data upload to the server. Each of the clients 100 may also be assigned a client identification number. Further, the data requirements 100 may be utilized to set up various data fields to create a patient health profile, described below with respect to FIG. 2. These data fields may govern the type of information that may be collected from each patient to create a unique patient health profile. Additionally, as also described below, the data requirements 104 may be set up for automatic download as new patient profiles are created or alternatively, within set periods of time.

Client and user information 106 may also be entered into the client database 102. The criteria to determine re-contact inclusion/exclusion criteria as well as re-contact priority order 108 may be determined as well. Client and user information 106 may include the contact information (e.g., name, e-mail address, phone number, etc.), designation (e.g., technician, physician, callback clerk, on-duty staff, etc.), department, and any other information that may be deemed useful in identifying any personnel who may use the patient callback system 2.

Trigger notifications 110 to contact any of the designated personnel (described below), the desired manner of contact with those personnel, assessment questions and responses 112 and any actions 114 to be taken upon receiving the responses from the patients may all be set in the client database 102. Various time periods 116, such as, how long after discharge to contact a patient, when to send a self-assessment and/or callback, etc may be set as well. An electronic message master switch 118 may be used to enable or disable contact with the patients.

It will be understood that while the steps above to setup the client 100 have been described in a specific order, in at least some embodiments, the order of the steps may be changed as desired. Further, as appropriate, one or more steps may be replaced by other desired steps or some steps may be skipped as well. In other words, the client setup is flexible and may be tailored to suit the client's needs.

Referring now to FIG. 2, the patient callback system 2 is shown, in accordance with at least some embodiments of the present disclosure. The patient callback system 2 may be utilized to contact a patient 4 discharged from the medical facility 6. The patient 4 may be contacted, for example, to determine their health condition since discharge, as well as to solicit feedback about their experience at the medical facility 6. As defined herein, the term “patient” may include human or animal patients, and where applicable, the term “patient” may also include representatives, agents or guardians of the patients. While the patient callback system 2 has been shown to contact the patient 4 discharged from the medical facility 6, it will be understood that the callback system may be utilized in any application where a response, feedback or follow-up from a user is desired. The term “user” as used herein may include person or persons, animals, parties or entities that are customers, patrons or otherwise receive/use any form of services, whether professional or social.

To facilitate contact with the patient 4, a patient profile document may be created when the patient first receives treatment at the medical facility 6. The patient profile document may be uploaded to the server 8, as indicated by communication link 10. The patient profile document may include (although not necessarily) a set of protected health information (PHI), such as, patient's name, date of birth, address, gender, phone number(s), e-mail address, date/time of arrival and discharge, reason for visit, name and identification of the care provider(s), native language, insurance information, etc. It will be understood that the above is a non-exhaustive list of information that may be a part of the patient profile. Other types of information such as, emergency contacts, etc., that may be deemed useful by the medical facility 6, may be part of the patient profile as well. The patient profile document may additionally include various patient preferences and privileges, such as, the patient's preferred mode of contact by the medical facility 6 (e.g., via text message, e-mail and/or telephone), number of attempts to be made by the medical facility to contact the patient 4, how long after discharge to be contacted, level of patient's access to the patient callback system 2, etc. Although not recommended, the patient 4 may also opt out of any contact by the medical facility 6.

The upload of the patient profile document to the server 8 may be automatically performed via secure connections and protocols (e.g., secure file transfer protocols). Information may be uploaded to the server either when a new patient profile document is created or when additional information for an existing patient profile document is available. The frequency of uploading information to the server 8 may also be set as desired. For example, information may be automatically uploaded to the server 8 at either fixed times of the day (or night), instantly as the information becomes available, and/or within specified intervals of time. Furthermore, the patient profile may be transferred to the electronic data records of the medical facility 6 and/or printed for paper medical records.

With respect to the server 8, it may be any of a variety of server systems that are commonly used in medical facilities. In at least some embodiments, the server 8 may be a cloud server based upon a cloud computing model. Cloud computing may be defined as a model for enabling ubiquitous, convenient, on-demand network access to a shared pool of configurable computing resources (e.g., networks, servers, storage, applications, and services). Cloud computing is well-known and, therefore, has not been described here in great detail. Any of a variety of cloud computing models that may be appropriate for purposes of the medical facility 6 may be used for the server 8. In other embodiments, other types of application, file, database, web servers and the like, may be used as well. Furthermore, the server 8 may be a stand-alone or networked embedded or other physical computer system designed to run one or more services or serve the needs of the medical facility 6. The server 8 may include any of a variety of volatile or non-volatile memory/storage devices, such as, flash memory, read-only memory (ROM), programmable read-only memory (PROM), erasable programmable read-only memory (EPROM), electronically erasable programmable read-only memory (EEPROM), etc., computing and processing devices, such as, microprocessors and central processing units, and computer readable media, such as, joysticks, flash drives, optical disc drives, floppy discs, magnetic tapes, drums, cards, etc. The server 8 may also include output and display devices such as monitors and printers. Other types of computing, processing as well as reporting and storage devices may be present within (or used in conjunction with) the server 8. Furthermore, a variety of devices, systems and software that are commonly employed in combination or conjunction with servers, such as power supplies, fault tolerance systems, etc. are contemplated and considered within the scope of the present disclosure.

The server 8 may run one or more software programs or applications stored in a memory location, read from a computer readable medium, and/or accessed from an external device operatively coupled to the server by any suitable communication network. The server 8 may also be part of a client-server architecture where the server may be a computer program running to serve the requests of other programs, such as those at the medical facility 6. In that regard, the server 8 may perform computational task on behalf of the medical facility 6. Furthermore, patient information may be secured in a segregated manner on the server 8 with multiple-layer password protections and strict authentication processes. Data integrity may be assured by various encryption protocols and the server 8 may be authenticated with extended validation certificates. Other types or levels of security, such as, firewalls, may also be in place to protect the server 8 itself, as well as the information of the patient 4.

After the patient 4 is discharged from the hospital or clinic 6, the callback system 2 may be utilized to contact the patient. The contact may be in the form of a survey. As will be described further below, the survey may either be completed independently by the patient 4 or with the assistance of a callback clerk 20. The purpose of the survey may be to determine the well-being and recovery of the patient 4 since discharge from the medical facility 6, elicit feedback about the patient's experience at the medical facility, experience with various care providers, as well as any other feedback or concern that the patient (or those filling out the survey) may have. As stated above, the survey may be completed in at least two ways: self-assessment (the patient completes the survey independently) or callback (the patient completes the survey with the help of the callback clerk 20). In self-assessment, the survey may be sent to the patient 4 and the patient (or patient's representative) may complete the survey on their own within a specified period of time and subsequent to completing the survey, the patient 4 may return the survey to the medical facility 6. To complete the survey by callback, the patient 4 may receive a call from the callback clerk 20, who may collect the patient's responses and complete the survey.

The survey may be designed and created to address the needs of the patient 4, as well as of the medical facility 6. In at least some embodiments, the survey may be designed and/or created by the medical facility 6 itself. In other embodiments, the survey may be designed and/or created by a third party and used by the medical facility 6. Each survey may be tailored for the patient 4 and may include a variety of questions, such as those asking about the patient's health and well-being since discharge from the medical facility 6, questions regarding medication, home-care, follow-up/discharge instructions and the like, questions asking the patient 4 to rate and evaluate his/her care providers at the medical facility, questions relating to the medical facility itself (such as cleanliness, facilities, ease of access, etc.) and other similar questions.

Furthermore, in at least some embodiments, all surveys may include some standard questions for the patients to answer, as well as some disease/condition or diagnosis specific questions that may be unique to a patient suffering/receiving treatment for that particular disease/condition or diagnosis. The survey may also include questions that address top medical problems associated with patient re-admission. For instance, a patient being treated with a congestive heart failure condition may be asked a few unique questions that may allow the patient's re-admission risk to be determined. If the risk is determined to be above a set threshold, then an intensive home care regimen may be initiated in order to assure a high chance of successful home care and reduced chance of re-admission. The callback clerk 20 may also be given the flexibility to ask questions from the patient 4 based upon the patient's risk threshold and disease/condition diagnosis/treatment.

Additionally, the questions may be multiple choice questions and/or may provide space that the patient 4 may supplement their responses in. The survey may also include various directions to aid the patient 4 for completing the survey in an effective manner, as well as instructions for the personnel/automated systems receiving the completed survey to follow-up diligently on the survey. Furthermore, the survey may be developed in the language specified by the patient 4 in his/her patient profile. Similar to the patient profile, the survey may be uploaded to the server 8 and may be linked to the patient profile of the patient 4. Once created, the questions in the survey may be continually modified, new questions added or irrelevant questions deleted to reflect the patient's follow-up care and needs. In addition, the survey may be created simultaneously with the patient profile, or any time thereafter. Thus, the survey may be very flexible such that the questions in the survey may be altered and tailored to address a specific patient's needs and reduce chances of re-admission.

After creating and uploading the survey, contact (either by way of self-assessment or callback) may be initiated by the medical facility 6. In at least some embodiments, the patient 4 may be able to specify, as part of the patient profile, the time period within which to be contacted by the medical facility 6 for completing the survey. Furthermore, a unique link to the survey may be generated by the server 8. The link may be a character string such as a uniform resource locator or URL containing a reference to an internet resource, such as, the server 8 where the survey may be located. The link may not contain any sensitive patient information. The server 8 may send the link to the patient 4 in various different ways. For example, in some embodiments, the server 8 may send a text message to a phone 12 via communication link 14. In other embodiments, the server 8 may e-mail the link to the survey to either the phone 12 or a computer 16 via communication link 18. In yet other embodiments, the server 8 may send the link to the survey to the callback clerk 20 (e.g., to a phone or computer used by the callback clerk, or alternatively a hard copy of the survey may be mailed to the callback clerk) via communication link 22. A hard copy of the survey may be mailed directly to the patient 4 as well.

It will be understood that the phone 12 may be representative of a cell or mobile phone and specifically, a smart phone, a landline phone, a telephony application programming interface (TAPI) phone, a voice over internet protocol (VoIP) phone or other types of phones or devices that are capable of receiving the link to the survey via a text message or e-mail. The patient 4 may utilize the phone 12 not only to receive the survey, but also to complete and return the survey back to the medical facility 6. Relatedly, the computer 16 may be representative of a laptop, desktop, notebook, netbook, tablet, or any other computing device capable of receiving e-mail and/or completing the survey. It will also be understood that while the patient 4 may receive the link to the survey via one medium (e.g., the phone 12 or the computer 16), the patient may utilize another medium (e.g., the phone 12 or the computer 16) to complete and return the survey. In at least some embodiments, the medical facility 6 may make an application, widget or the like available that the patient 4 may download on their phone 12 and/or computer 16 to access, complete and/or return the survey.

Furthermore, the callback clerk 20 may either be a person (such as a nurse) or alternatively, the callback clerk may be an automated processing control system designed to collect responses from the patient 4. When the callback clerk 20 is an automated processing control system, the callback clerk may have at least some of the same components as the server 8 described above, such as a memory system, a processing system, input and output devices and software designed to collect responses from the patient 4. The callback clerk 20 may also include one or more telephones and voice processing equipment to make phone calls and collect responses from the patient 4. The automated callback clerk 20 may also be linked to the server 8 (and possibly to other servers as well). When the callback clerk 20 is a person, the callback clerk may use any of a variety of ways, such as, phones (like the ones the patients 4 may use) and/or computers (also similar to those described above), including any tablets, smart-phones, applications, widgets, etc.

After the link to the survey is sent to the patient 4, the patient may access the survey by clicking that link. As shown herein, the patient 4 may access the survey from the text message or the e-mail containing the link to the survey, as represented by communication links 24 and 26. Furthermore, the patient 4 may complete the survey on his/her phone 12 and/or the computer 16 by following the instructions on the survey (self-assessment). The survey may also specify a certain time period for the patient 4 to respond back with the completed survey. Upon failing to complete and return the survey within that time period, the patient 4 may receive a phone call from the callback clerk 20 to complete the survey, as indicated by communication link 28. The patient 4 may also receive a call from the callback clerk 20 if the patient had specified callback as an option for completing the survey. The questions of the survey, whether completed by the patient through self-assessment or via callback, are typically the same although, as described above, the callback clerk may have some flexibility in tailoring the questions depending upon the patient's condition at the time of the phone call.

Once the survey is completed and returned (either via self-assessment or by callback) to the medical facility 6, several actions may be taken. These actions may be dependent upon the responses of the patient 4 in the survey. Some actions may be triggered instantly and/or automatically, while other actions may be pipelined and saved for later review. For example, when the patient 4 reports a medical or follow-up concern, built-in triggers in the survey may automatically notify on-duty staff 30 via communication link 32. The on-duty staff 30 may contact the patient 4 and address the concern, as shown by communication link 34. The on-duty staff 30 may be a primary care physician and/or a home health agency that receives the trigger notifications and provides decision support in order to reduce medical facility re-admissions, which has increasingly become a high level goal. Each of the discharged patients 4 may be assigned to a specific on-duty staff 30. In addition, when the patient 4, while completing the survey, indicates a worse medical condition since being discharged from the medical facility 6, the survey may ask additional questions to recommend a course of action even before the on-duty staff 30 responds back.

Other types of survey responses, such as those relating to satisfaction concerns and other issues related to the care providers, as well as the medical facility 6 are relayed to various designated managers and directors 36 via communication link 38. For example, feedback related to doctors may be conveyed to designated doctor directors, while feedback related to nurses and care providers other than doctors may be relayed to designated nurse directors. Similarly, feedback regarding the medical facility 6 may be relayed to the designated facility directors. Furthermore, each of the designated directors 36 may specify the manner in which to receive the survey responses and, thus, responses to each designated director may be tailored to their respective preferences. The designated directors 36 may also specify whether to receive the responses immediately when a completed survey is returned or after a delay and upon compiling responses from multiple surveys. Furthermore, certain types of responses may be reported to the designated directors 36 right away irrespective of the directors' set preferences. After receiving the responses, the designated directors 36 may address the concerns of the patient 4, as represented by the communication link 34. Typically, although not always, the on-duty staff 30 may have a higher priority over the designated directors 36 in addressing the concerns of the patient 4.

In addition to addressing the concerns of the patient 4, the survey may also be utilized to prepare various reports and conduct a detailed reporting 40 of the responses. Specifically and as indicated by communication link 42, detailed reports containing departmental demographics, assessment results, and staff performance may be generated. The various reports may be generated daily, weekly, monthly or as desired. Staff performance or individual provider reports may include metrics related to productivity, satisfaction and utilization. For example, at least some of the detailed staff reporting may include information on one or more of the following: (a) average number of patients seen per hour; (b) average workload per hour (based on patient acuity and disposition); (c) percentage of satisfied and dissatisfied patients; and (d) relative satisfaction on a percentile basis relative to the same provider in the past, other providers in same department, and with other clients. It will be understood that the list above is non-exhaustive and may include reports on several other parameters that may be deemed useful for either a specific group of care providers or as requested by an individual care provider. Relatedly, departmental reports may include results such as average time a discharged versus admitted patient spends in a specific department.

Various other types of reports may be prepared and other information may be collected from the survey responses in order to improve customer satisfaction, improve the medical facility 6, as well as evaluate the efficiency and productivity of the care providers. Responses from multiple surveys from various patients may be gathered to compile the detailed reports 40.

### INDUSTRIAL APPLICABILITY

Thus, the present disclosure sets forth a callback system that may be utilized to contact patients discharged from a medical facility after receiving a treatment. After being discharged, the patients may be sent a survey to complete. The patients may have the option to complete the survey independently (self- assessment) or with help from a callback clerk (callback). Based upon the patient's responses, various actions may be taken by the medical facility. For example, any medical concerns may be addressed immediately or quickly by an on-duty staff. Other types of concerns relating to the medical facility and/or the care providers may be parsed and compiled in the form of various reports. Designated directors may also be informed of concerns regarding their respective fields.

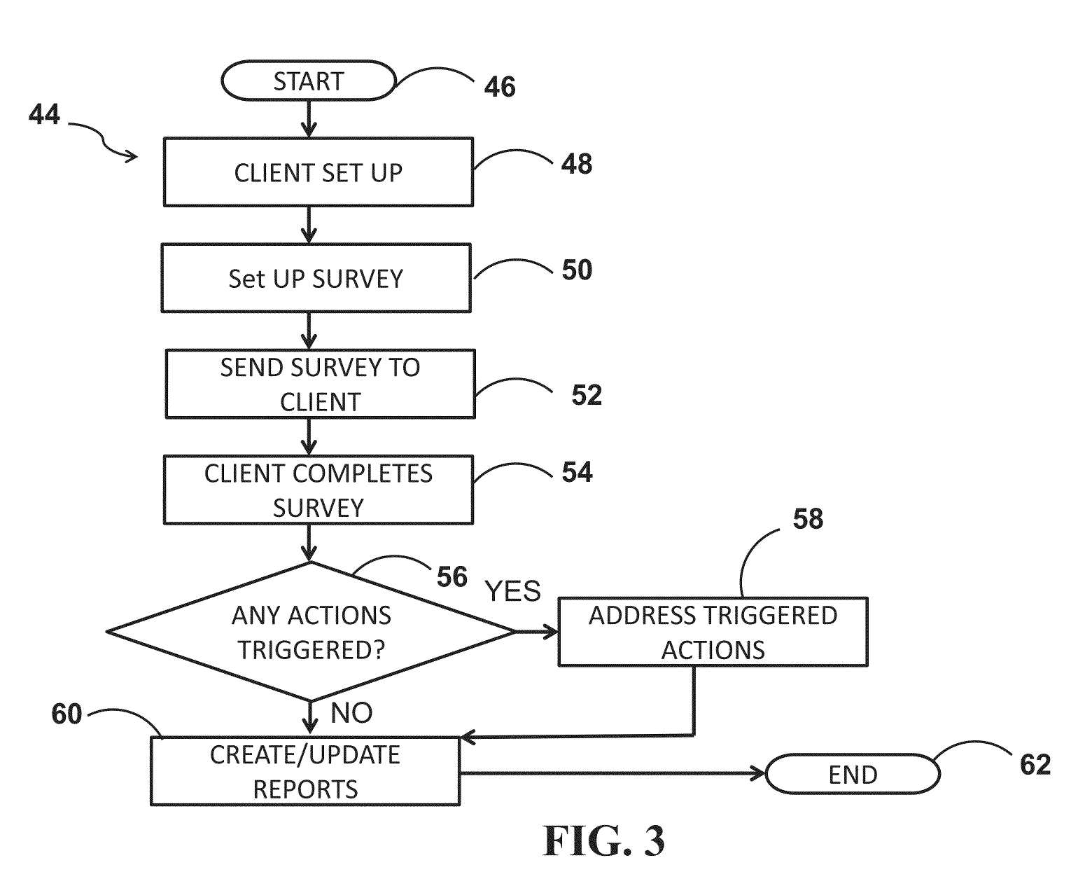

Turning now to FIG. 3, a flowchart 44 outlining the steps in contacting the patient 4 and completing the survey is shown, in accordance with at least some embodiments of the present disclosure. After starting at a step 46, a patient profile is created at a step 48. As discussed above, a patient profile may be created when the patient 4 checks in to the medical facility 6 for treatment. If the patient 4 has been to that specific medical facility 6 before, a patient profile for that patient may already exist. In that case, the patient profile may be updated to account for any new information. As also discussed above, the patient profile may include patient's name, age, gender, mailing and/or e-mail address, phone numbers, emergency contact, treatment received and/or recommended, medication list, immunizations if applicable, other health information, associated identities of care providers, any discharge instructions, language preference, and other user preferences and privileges such as how to receive and complete the survey, etc. Other types of information that may be useful in rendering care to the patient 4 may be present within the patient profile. In at least some embodiments, the patient profile may also be referred to as a client profile. The patient profile may be uploaded to the server 8.

Next, at a step 50, a survey may be created for the patient 4. Typically, the survey may be created upon the patient's discharge from the medical facility 6, although the survey may be created simultaneously with the patient profile or at any point after that. The survey may be specifically tailored to the needs of the patient 4, as well as may include questions for improving the patient's experience at the medical facility 6 and for evaluating the care providers. Specifically and as discussed above, the survey may include problem-specific question sets for the patient 4. These question sets may include critical questions that indicate that the patient is at high risk for re-admission. When the risk exceeds built-in thresholds, a trigger notification may occur according to the preferences of the medical facility 6.

The survey may be linked to the patient 4 and may also be uploaded to the server 8. In addition, a unique link may be generated by the server 8 for the survey. After uploading the survey to the server 8 and creating the unique link, the survey may be sent to the patient 4 at a step 52. As discussed above, the link may be sent to the patient 4 via one or more methods specified by the patient in his/her patient profile. For example, the link may be sent via a text message, an e-mail, a hard copy or the patient may choose to complete the survey with the help of a callback clerk.

In at least some embodiments, the patient 4 may first receive the link to the survey for completion via self-assessment and then, if the patient does not respond back within a specific time period, the call back clerk 20 may call the patient for completing the survey. In at least some other embodiments, the patient 4 may choose to receive the call from the callback clerk 20 first to complete the survey via callback. When the patient 4 completes the survey via the callback clerk 20, the callback clerk may recommend any immediate actions (such as going to the emergency department, administering certain medications, etc.) based upon the patient's medical condition. The callback clerk 20 may also escalate the patient's medical condition to the on-duty staff 30.

Furthermore, the callback clerk 20 (as well as other staff members of the medical facility), upon recording patient answers/suggesting actions, may have an option of raising various flags. For each issue, the callback clerk 20 may raise one of three types of flags: “none,” which is a default flag indicating no further action is to be taken, “open,” which indicates an open issue that needs to be addressed, either by the on-duty staff 30, by the designated directors 36 or by some other entity within the medical facility 6 and “closed,” which indicates that an open issue has been resolved and that the flag has been changed from “open” to “closed.” Each flag (and particularly, the “open” and “closed” flags) may have associated with it a description box in which the callback clerk 20 may describe the issue to be addressed (for the “open” flag) or how the issue was addressed (for the “closed” flag). The description within the box of the “open” flag may be updated periodically until the flag is “closed.” Additionally, the flags may be searchable to, for example, find all “open” flags, to determine which issues are outstanding. When the patient 4 completes the survey by self-assessment, the on-duty staff 30 may raise the above described flags for further action. Insofar as the flags assist the callback clerk 20 to keep track of any “open” or “closed” issues, the flags may also be termed as “issues trackers.” These issue trackers help with unusual occurrences and assist the callback clerk 20 (and other staff) in keeping track of issue progress and resolution.

Whether the survey is completed by self-assessment or by callback can be specified by the patient 4 as part of the patient profile or at the time of discharge. At the time of discharge, the patient 4 may be placed on a callback queue. When the patient 4 successfully completes the survey either by self-assessment or by callback, the patient may be removed from the callback queue. The patient 4 may also opt out of any future or follow-up surveys from the medical facility 6. In at least some embodiments, the patient 4 may even opt out from the first survey that is received by the patient after discharge. Reminders may be sent (via text, e-mail or hard copies) to the patient 4 for completing the survey (unless the patient has opted out of the survey). In at least some embodiments, the reminder may be sent to the patient 4 in the form of a call from the callback clerk 20.

After completing and returning the survey at a step 54, the responses of the survey may be evaluated to determine if any immediate or quick follow-up actions are needed at a step 56. For example and as discussed above, if the patient 4 indicates that his/her health condition has been deteriorating since discharge from the medical facility 6, the on-duty staff 30 may be notified at a step 58. The on-duty staff 30 may address the patient's concern(s) in one or more of several ways such as, but not limited to, by calling the patient, faxing, e-mailing or texting additional instructions to the patient, simultaneously notifying the associated care provider in addition to contacting the patient, etc. Additionally, at the step 58, responses of the patient 4 related to specific care providers and the medical facility itself may be conveyed to the respective designated directors 36, as discussed above.

If no immediate or quick follow-up actions are required, then at a step 60, responses of the survey may be compiled into one or more new or pre-existing reports. Similarly, after the on-duty staff 30 address the concern(s) of the patient 4, the patient profile may be updated to include the follow-up actions, as well as the responses may be captured in the reports at the step 60. The process then ends at a step 62.

Thus, the callback system provides an innovative communication system that various medical facilities can utilize in pertinent service areas to facilitate patient contact after a discharge from the medical facility and/or after an emergency department visit/outpatient procedure. A sequential and blended approach (by both messaging and telephone) minimizes the cost per contacted individual. Performance metrics generated for each care provider with ample granularity provide meaningful monthly comparisons. Comments of praise and criticism facilitate self-improvement. Internal benchmarking and goal setting result in a workforce motivated to improve patient experience. External benchmarking improves a client's (e.g., the medical facility 6) ability to compete for patient loyalty.

In addition, contacting the patient after discharge heightens patient experience and helps uncover and swiftly address any lingering patient concerns. Proactive patient engagement facilitates communication between patients and healthcare providers and avoids re-admission into the facility because of deteriorating medical conditions. Such patient communication after a transition of care (hospital to home, emergency department to home, or outpatient procedure to home) also improves patient safety and mitigates medical-legal risk for clients.

It will also be understood that while the disclosure above has been explained with respect to a medical facility, the teachings of the disclosure are equally applicable (with apparent modifications) to other application areas, such as, for marketing purposes, etc.

While only certain embodiments have been set forth, alternatives and modifications will be apparent from the above description to those skilled in the art. These and other alternatives are considered equivalents and within the spirit and scope of this disclosure and the appended claims.

What is claimed is:

1. A method of collecting feedback from a user, the method comprising:
providing a server capable of storing a survey and generating a unique link to access the survey on the server, the server further capable of sending the unique link to at least one of the user and a callback clerk;
completing the survey by the user and returning the completed survey to the server, the server capable of compiling responses in the survey;
determining by the server if any actions in the completed survey have been triggered, the server further capable of at least indirectly addressing the triggered actions; and
gathering the responses in the survey into at least one report by the server.

2. The method of claim 1, wherein the unique link to the survey is sent via at least one of text and e-mail to the user.

3. The method of claim 1, wherein the user is capable of accessing the unique link and completing the survey using a web enabled phone.

4. The method of claim 1, wherein the user is capable of accessing the unique link and completing the survey using a web enabled computer.

5. The method of claim 1, wherein the callback clerk is capable of completing the survey on the user's behalf by calling the user and soliciting responses to questions in the survey.

6. The method of claim 1, wherein determining by the server if any actions have been triggered comprises determining if a medical condition of the user is worse than before.

7. The method of claim 7, wherein if the medical condition is worse, the server automatically alerts an on-duty staff to address the user's concern.

8. The method of claim 1, wherein determining by the server if any actions have been triggered comprises determining if the user has given any feedback regarding one or more care providers.

9. The method of claim 9, wherein if any feedback regarding the care providers is provided by the user, the server notifies at least one designated directors of the care providers.

10. The method of claim 1, wherein the at least one report may include at least one of departmental demographics, assessment results, and staff performance.

11. A system to collect feedback from a user, the system comprising:
a server capable of storing a survey and generating a unique link to access the survey on the server, the server further capable of sending the unique link to at least one of the user and a callback clerk using a web enabled device;
a user profile document designed to be automatically uploadable to the server, the survey tailored to the user profile;
on-duty staff for quickly addressing a first type of user concern;
designated directors for addressing concerns of a client and a second type of user concern; and
a reporting system for collecting information from the survey for future use.

12. The system of claim 11, wherein the callback clerk is an automated system capable of calling the user and soliciting responses to questions in the survey.

13. The system of claim 11, wherein the client is a medical facility.

14. The system of claim 13, wherein the user is a patient discharged from the medical facility.

15. The system of claim 14, wherein the patient is placed in a callback queue upon being discharged from the medical facility, the callback queue determining when to contact the patient for completing the survey.

16. The system of claim 15, wherein the patient is removed from the callback queue after the survey is completed.

17. A method of contacting a patient discharged from a medical facility, the method comprising:
providing a server capable of storing a survey and generating a unique link to access the survey on the server, the server further capable of sending the unique link to at least one of a patient and a callback clerk;
creating a patient profile document for the patient by the medical facility and uploading the patient profile document on the server;
creating the survey tailored to the patient profile document by the medical facility and uploading the survey on the server;
completing the survey by the patient using at least one of a web enabled device and the callback clerk and returning the completed survey to the server;
reviewing the completed survey by the server to determine if any actions have been triggered; and
addressing the triggered actions by the server.

18. The method of claim 17, further comprising compiling information in the survey into one or more reports by the server.

19. The method of claim 17, wherein determining by the server if any actions have been triggered comprises determining if a medical condition of the patient is worse than when the patient was discharged from the medical facility and if so, notifying an on-duty staff.

20. The method of claim 17, wherein the web enabled device includes at least one of a web enabled phone and a web enabled computer.
